(19) United States
(12) Patent Application Publication
(10) Pub. No.: US 2017/0319295 A1
(43) Pub. Date: Nov. 9, 2017

(54) FLEXIBLE ORTHODONTIC DEVICE AND METHODS OF USE

(71) Applicant: Richard Bach, Westhampton Beach, NY (US)

(72) Inventor: Richard Bach, Westhampton Beach, NY (US)

(21) Appl. No.: 15/118,885

(22) PCT Filed: Feb. 27, 2015
(86) PCT No.: PCT/US15/17929

§ 371 Date: Aug. 14, 2016

Related U.S. Application Data
(60) Provisional application No. 61/945,177, filed on Feb. 27, 2014.
(60) Provisional application No. 62/077,293, filed on Nov. 9, 2014.

(51) Int. Cl. A61C 7/14; A61C 7/28

(52) U.S. Cl. CPC A61C 7/145; A61C 7/28; A61C 2201/007

(57) ABSTRACT

An orthodontic device is disclosed comprising a head configured to be coupled to a tooth, the head having a first geometric configuration such that actuation of the head facilitates adjustment of the tooth, a neck adjacent the head to facilitate coupling of the head to the tooth, the neck having a second geometric configuration, the neck operable to transfer a force exerted on the head to the tooth and at least one of the neck and the head comprising a flexible material. In some embodiments, the orthodontic device further comprises a member operable to engage the head such that actuation of the head facilitates physical adjustment of the tooth and the member comprises an aligner and the aligner further comprises at least one well configured to engage the head.

### CROSS-REFERENCE TO RELATED APPLICATIONS

This application claims the benefit of U.S. Pat. App. No. 61/945,177, filed on Feb. 27, 2014, entitled “FLEXIBLE ORTHODONTIC DEVICE” and U.S. Pat. App. No. 62/077,293, filed on Nov. 9, 2014, entitled “FLEXIBLE ORTHODONTIC DEVICE AND METHODS OF USE”, the entire content of both is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### 1. Field of the Invention.

The present disclosure relates to the field of orthodontics, more specifically, to a flexible orthodontic device (FOD) configured to be coupled to a dental surface for adjustments thereof for a patient undergoing orthodontic treatment. In some embodiments, the flexible orthodontic device is used with an aligner such as a polymeric shell aligner to reposition a tooth.

### 2. Background.

Orthodontic treatment involves the repositioning of misaligned teeth and improving bite configurations for improved dental function and cosmetic appearance. Repositioning teeth may be accomplished by applying controlled forces to the teeth over an extended period of time. A number of systems and techniques are known for applying the required forces to the teeth. Orthodontic systems such as braces have traditionally been used to reposition teeth by applying forces to teeth through wires and bracket devices attached to the teeth. Recently, additional alternatives such aligners have been introduced to apply forces to reposition teeth.

### BRIEF SUMMARY OF THE INVENTION

The following summary is included only to introduce some concepts discussed in the Detailed Description below. This summary is not comprehensive and is not intended to delineate the scope of protectable subject matter, which is set forth by the claims presented at the end of this disclosure.

The present disclosure is directed to an orthodontic device configured to be coupled to a dental surface for adjustments thereof for a patient undergoing orthodontic treatment. The orthodontic device may include a head that can be configured to be attachable or coupled to a tooth, the head having a geometric configuration such that actuation of the head facilitates adjustment of the tooth. The device may also include a neck adjacent the head to facilitate coupling or attachment of the head to the tooth, where the neck is capable of transferring forces exerted on the head to the tooth. In some instances, a base material may be used to facilitate attachment or coupling of the neck to the tooth, the base including at least one of adhesive, paste, cement and bonding material.

In some embodiments, an orthodontic device is provided comprising a head configured to be coupled to a tooth, the head having a first geometric configuration such that actuation of the head facilitates adjustment of the tooth, a neck adjacent the head to facilitate coupling or attachment of the head to the tooth, the neck having a second geometric configuration, the neck operable to transfer a force exerted on the head to the tooth; and at least one of the neck and the head comprising a flexible material.

In some embodiments, an orthodontic device is provided comprising a head configured to be coupled to a tooth, the head having a first geometric configuration such that actuation of the head facilitates adjustment of the tooth, a base coupled to the head to facilitate coupling of the head to the tooth, the base operable to transfer a force exerted on the head to the tooth and one of the base or the head comprising a flexible material.

In some embodiments, an orthodontic system configured to transfer a force to a tooth is provided, the system comprising an orthodontic device configured to be attached to the tooth, the flexible orthodontic device including a head, a base coupled to the head, the head having a geometric configuration and one of the head or the base having a flexible portion comprising a flexible material; and an agent/member operable to engage the head such that actuation of the head facilitates physical adjustment of the tooth.

In some embodiments, the orthodontic device includes a head configured to be attachable to an exterior portion or surface of a tooth, the head having a geometric configuration such that actuation of the head facilitates adjustment of the tooth. In another embodiment, the device includes a neck adjacent the head to facilitate attachment of the head to the tooth, where the neck is capable of transferring forces exerted on the head to the tooth. In some embodiments, the device includes a base material to facilitate attachment of the neck to the tooth, where the base material can be an adhesive, paste, cement or bonding material.

In some embodiments, each of the head and the neck of the orthodontic device can be made of a flexible or elastic material such as but not limited to natural rubbers, rubbers, colloids, hydrocolloids, gels, silicones, polymers, elastomers, super-elastic metal alloys or crystals. In the alternative, the head can be made of a rigid material while the neck can be made of a flexible or elastic material such as but not limited to natural rubbers, rubbers, colloids, hydrocolloids, gels, silicones, polymers, elastomers, super-elastic metal alloys or crystals. In some embodiments, the neck can be made of a rigid material while the head can be made of a flexible or elastic material such as but not limited to natural rubbers, rubbers, colloids, hydrocolloids, gels, silicones, polymers, elastomers, super-elastic metal alloys or crystals.

In some embodiments, the flexible material is an elastic material having an Elastic Modulus in one of compression or tension less than about 30.6×10⁷ gf/cm² (grams-force per square centimeter). In some embodiments, the flexible material is an elastic material having an Elastic Modulus in one of compression or tension less than about 0.3×10⁷ gf/cm². In some embodiments, the flexible material is an elastic material having an Elastic Modulus in one of compression or tension less than about 0.1×10⁷ gf/cm².

In some embodiments, the flexible material is configured to absorb a portion of the force as a potential energy and transfer the force in a range of about 5-300 grams-force to the tooth over a displacement of the device of at least about 1.0 mm.

In some embodiments, the geometric configuration of the head or the neck of the device may include a two-dimensional cross-sectional profile including one of a circle, an ellipse, a triangle, a square, a rectangle, a parallelogram, a diamond, a pentagon, a hexagon, an octagon, a polygon and a trapezoid. In some embodiments, the geometric configuration of the head or the neck of the device may also include a three-dimensional shape including one of a polyhedron, a cube, a sphere, a cone, a cylinder, a ball, a prism and a pyramid.

In some embodiments, the geometric configuration of the device defines an Elastic Modulus in flexure of the neck that is less than an Elastic Modulus in flexure of the head.

In some embodiments, the head comprises a Teflon material and the neck comprises a nitinol coil spring.

In some embodiments, the flexible material is configured to absorb a portion of the force as a potential energy and transfer the force in a range of about 10-300 grams-force to the tooth over a displacement of the device of at least about 1.0 mm. In some embodiments, the flexible material is configured to absorb a portion of the force as a potential energy and transfer the force in a range of about 25-150 grams-force to the tooth over a displacement of the device in a range of about 0.5-1.0 mm.

In some embodiments, an orthodontic treatment system is provided comprising an orthodontic device configured to be attached to the tooth via a base material. In some embodiments, the device may be coupled to the tooth and may include a head coupled to the neck or the base and . The system may also include an external agent or member capable of engaging the head such that actuation of the head facilitates physical adjustment of the tooth.

In some embodiments, an orthodontic system for repositioning a tooth is provided, the orthodontic system comprising an orthodontic device comprising a head and a neck configured to be coupled to a tooth, the head having a first geometric configuration such that actuation of the head facilitates repositioning the tooth, the neck adjacent the head to facilitate coupling of the head to the tooth, the neck having a second geometric configuration, the neck operable to transfer a force exerted to the head to the tooth, at least one of the neck and the head comprising a flexible material, a polymeric shell aligner having at least one well and a well contact surface, the head configured to be removably received in the well and the head having a head contact surface configured to engage the well contact surface whereby the well contact surface is capable of transferring the force to the head contact surface and actuating the head.

In some embodiments, the base material for bonding the device to the tooth includes at least one of adhesive, paste, cement or bonding material. In another embodiment, the external agent/member includes at least one of rigid metal, plastic, orthodontic aligner such as a polymeric shell aligner or metal spring. In operation, the neck is capable of transferring forces exerted on the head to the tooth.

In operation, a method of using an orthodontic device for orthodontic treatment includes attaching or coupling the device to a tooth using a bonding agent. The device includes a head and a neck or base coupled or connected to the head. The method further includes actuating the head such that actuating the head facilitates physical adjustment of the tooth.

In some embodiments, attaching or coupling the device to the tooth includes attaching using the bonding agent, the bonding agent being at least one of adhesive, paste, cement or bonding material. In other embodiments, actuating the head includes exerting forces in any direction to include lateral forces, longitudinal forces, push forces, pull forces or twisting forces on the head. In yet other embodiments, actuating the head can be carried out with an external agent/member including at least one of rigid metal, plastic, orthodontic aligner such as a polymeric shell aligner or metal spring.

Other variations, embodiments and features of the present disclosure will become evident from the following detailed description, drawings and claims.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. This disclosure will be described with respect to the accompanying drawings in which like elements are accompanied by like numerals.

Understanding that these drawings depict only example embodiments of the invention and are not therefore to be considered to be limiting of its scope, the invention will be described and explained with additional specificity and detail through the use of the accompanying drawings in which:

FIG. 1 is a side view of a flexible orthodontic device (FOD) according to one embodiment of the present disclosure;

FIG. 2A is a side view of an example embodiment of a FOD;

FIG. 2B is a side view of an example embodiment of a FOD coupled to a tooth;

FIG. 3 is a top view of an example embodiment of a FOD for an orthodontic treatment system;

FIG. 4A and 4B show load/deflection graphs illustrating example working ranges of example FODs;

FIGS. 5A and 5B illustrate side perspective and top perspective views of an example embodiment of a FOD;

FIGS. 6A and 6B illustrate side perspective and top perspective views of an example embodiment of a FOD;

FIGS. 6C and 6E illustrate side and side perspective views of an example embodiment of a FOD;

FIG. 6D illustrates cross-sectional profiles of an example embodiment of a FOD;

FIGS. 7A-7C illustrate different configurations of a head with a neck for a FOD;

FIGS. 8A-8C show top perspective, side and front views of an example embodiment of a FOD engaged with an example embodiment of an external agent/member;

FIGS. 9A-9D illustrate the operation of an example embodiment of a FOD with a flexible head; and

FIGS. 10A-10D illustrate the operation of an example embodiment of a FOD with a flexible neck.

### DETAILED DESCRIPTION OF THE INVENTION

Orthodontic devices and members including a flexible orthodontic device (FOD) and methods of their use will now be described in detail with reference to the accompanying drawings. It will be appreciated that, while many of the following description describes orthodontic devices used with aligners such as polymeric shell aligners, the embodiments disclosed herein can be embodied in other specific forms without departing from the spirit or essential character thereof. For example and not for limitation, the embodiments described herein may be readily employed with traditional orthodontic arch wires, retainers, elastic bands or embodiments that use teeth to apply actuation forces. Notwithstanding the specific example embodiments set forth below, all such variations and modifications that would be envisioned by one of ordinary skill in the art are intended to fall within the scope of this disclosure.

As used herein, in addition to the normal meaning of the word in the art, the term flexible includes any type of ability to deform in reaction to a force without breaking. Flexible includes being elastic which includes being able to deform from an original shape to a deformed shape in reaction to a force and having the tendency to return towards some or all of the original shape upon removal of the force. Deformation, including elastic deformation, may be any type of deformation such as but not limited to bending, compressing, stretching, twisting, flexing or deflecting. A flexible material is in contrast to a rigid or stiff material.

In general, some embodiments of the FOD comprise elements that are capable of translating forces to a tooth through a portion of the FOD that is flexible. The elastic nature of a portion of the FOD itself allows effective force transmission to the tooth and the root. The flexible properties of that portion of the FOD allows deformation of portions of the device itself so that the device is not merely an intermediary surface that transmits the force of the outside agent, but one of the force generating mechanisms which, by being attached to the tooth, generates efficient translation or application of the force over time or displacement, which can be force moments, directly to the root. The Elastic Modulus of the material, when combined with the size and shape of the attachment, allows the FOD to be displaced in any or all of 3 dimensions at the same time so that the resulting force applied directly to the tooth is within the range for optimal tooth/root movement approximating, but not limited to 0-500 grams-force or 0.0-490.3325 cN.

The FOD may be used with any type of external agent/member, for example and not for limitation an orthodontic aligner such as a polymeric shell aligner, a retainer, an orthodontic wire or an elastic band. When combined with external agents/members such as orthodontic aligners, the FOD may reduce the variability of force and/or moment application inherent in aligner application by adding a second, sometimes more predictable, application of force and/or moments to enhance those force and/or moments that are not constant in the application of the aligner forces due to (1) the variable properties in the aligner caused by variable shapes and thicknesses of the same material, and (2) the inefficiencies inherent in loss of aligner force application due to the sliding action between the non-perpendicular planes of the aligner and the planes of the tooth surface or rigid attachments applied to the tooth surface, and 3) the absence of a neck, or stem-type structure that enables full seating of the force receiving component fully into the aligner well to prevent slippage between the aligner and the FOD. Similar benefits may be gained when the FOD is used with an external agent/member such as an orthodontic arch wire or an elastic band.

The flexible properties (including elastic properties) also may allow portions of the FOD to absorb and store elastic energy and release that energy as a force over time and/or over a displacement of the FOD. This elastic energy may be in addition to any elastic energy that may be stored in the agent/member or other elements of an orthodontic system.

The force transmitted by the FOD may result in efficient tooth movement regardless of the rigidity or flexibility of the outside force generating mechanism. The result is that the FOD can be used alone with an essentially rigid deflector or agent/member to effect tooth movement or the FOD can be applied with a deflector or agent/member that has flexible properties of its own in a manner that the combination of the properties may be more efficient than either component alone.

Some embodiments of the FOD are different than rigid orthodontic devices that have little if any flexibility and when engaged by an external agent/member that is rigid or having little flexibility, the work is done over a smaller distance. This type of rigid embodiment runs the risk of having too much force being applied to the tooth which does not allow the tooth to move or it requires multiple agent/device pairs (e.g., retainers) to be used to get the same tooth displacement.

Some embodiments of the FOD are different than orthodontic devices that provide forces through a flexing of the device. Some embodiments of the disclosed FOD are also able to provide forces onto the tooth by absorbing forces in compression or tension of the FOD. Depending on the geometric configuration and the material the FOD is made from, significant forces can be absorbed and released through the compression or tension of the FOD. These embodiments may allow for a broad range of forces onto and displacements of the tooth.

### Example Embodiments of an Orthodontic Device:

In some embodiments, an orthodontic device is provided comprising a head configured to be coupled to a tooth, the head having a first geometric configuration such that actuation of the head facilitates adjustment of the tooth, a neck adjacent the head to facilitate attachment of the head to the tooth, the neck having a second geometric configuration, the neck operable to transfer a force exerted on the head to the tooth and at least one of the neck and the head comprising a flexible material.

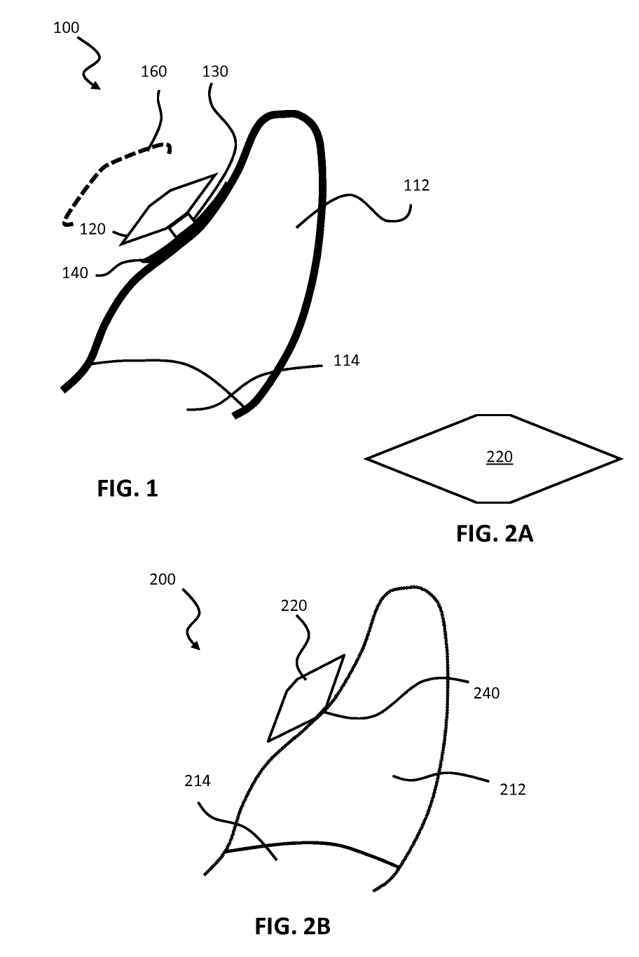

FIG. 1 shows a side (mesial or distal) view of a FOD 100 according to one embodiment of the present disclosure as it may be coupled or mounted on a tooth. This figure shows a tooth 112 such as crown or enamel on top of a root 114. The device 100 includes a head 120 configured to be coupled to the tooth 112. The head 120 has a geometric configuration such that actuation of the head 120 facilitates adjustment of the tooth 112 and the root 114. Coupling of the head 120 to the tooth 112 may be facilitated by a neck 130, the neck 130 capable of transferring a force exerted on the head 120 to the tooth 112. The neck 130 may have a geometric configuration that is able to facilitate a transfer of the actuation force applied to the head to a displacement force to adjust the tooth 112.

In some embodiments, a base 140 can facilitate coupling of the neck 130 and the head 120 to the tooth 112. The base 140 can be a bonding agent such as an adhesive or paste material (e.g., cement) to facilitate coupling of the neck 130 and the head 120 to a portion of the tooth 112 such as the enamel or crown. In some embodiments, the base 140 may comprise a base pad to provide a larger surface for bonding agent to bond with the attachment surface of the tooth 112 and enhance the application of complimentary moments of force from the FOD 100 to the tooth 112. The base pad may be coupled to the neck 130 or to the head 120 facilitating the bonding of the FOD 100 to the tooth 112. In some embodiments, the attachment of the FOD 100 by the base 140 can be direct or indirect using a bonding agent or cement such that the attachment is not permanent but secure enough to allow the orthodontic treatment to take place. The bonding agent may comprise a bonding material such as but not limited to at least one of adhesive, paste, cement and bonding material, to name a few.

In some embodiments, the neck 130 can have a smaller geometric footprint (e.g., lateral, horizontal, vertical) than the base 140, while the head 120 can have a greater geometric footprint (e.g., lateral, horizontal, vertical) than the neck 130 but smaller than that of the base 140. In other embodiments, the head 120, neck 130 and base 140 can have any suitable configuration and relative size to accommodate the tooth and the patient.

In some embodiments, the neck 130 may be a single element coupling a single element such as a head 120 to the tooth. This is in contrast to some embodiments that may have a plurality of elements functioning as heads and/or a plurality of elements functioning as necks to transfer actuation forces to the tooth 112.

In some embodiments, the FOD 100 may further comprise an external agent/member to provide actuation forces onto the head 120. The external agent/member may comprise an aligner, for example a polymeric shell, with one or more aligner wells that removably receive and engage the FOD 100. Shown in FIG. 1 is the interior wall profile of an aligner well 160 configured to engage the FOD head 120. This aligner and aligner well 160 may be a portion of a larger aligner and may provide actuation forces similar to those described in U.S. Pat. No. 8,708,697 issued on Apr. 29, 2014 and U.S. Pat. No. 8,562,337 issued on Oct. 22, 2013 both of which are herein incorporated by reference in their entirety. The polymeric shell aligner well may define a well contact surface and be configured to removably receive and engage a portion of the head in the well. The head of the device may be configured to have a head contact surface configured to engage the well contact surface whereby the well contact surface is capable of transferring the force to the head contact surface, the head and the tooth. As is shown in FIG. 1, in this type of embodiment, a stem-type structure of the neck 130 enables more of the head 120, as the force receiving component of the device, to be seated in the well 160 and reduce slippage between the aligner and FOD 100 while allowing for efficient translation of force component between the head 120 of the FOD 100 directly to the tooth 112.

The external agent/member may also be a traditional orthodontic arch wire or other traditional orthodontic devices such as but not limited to elastic bands, springs, retainers and head gear. These traditional orthodontic devices may be coupled with the geometric configuration of the head 120 or the neck 130 such that the agent/member provides the actuation force to the FOD 100.

In some embodiments, referring back to the elements of FIG. 1, the head 120, having any number of geometric configurations, can be attached to the tooth 112 with the use of the neck 130, optionally with only a bonding agent as the base 140. In other words, the neck 130 may be directly attached to the tooth 112. In such embodiments, adjustments or forces exerted on the head 120 and/or the neck 130 can be transferred to the tooth 112 through the bonding agent to facilitate orthodontic treatments thereof.

In some embodiments, the head 120, having any number of geometric configurations, can be attached to the tooth 112 with the use of the neck 130 and the base 140. In such embodiments, adjustments or forces exerted on the head 120 and/or the neck 130 can be transferred to the tooth 112 through the base 140 to facilitate orthodontic treatments thereof.

In some embodiments, as shown in FIG. 2B, the head 220, having any number of geometric configurations, may be directly attached to the tooth 212 without the use of the neck. FIG. 2A illustrates a cross-sectional profile from the side of the head 220 of FIG. 2B. In other words, the head 220 may be directly attached to the tooth 212 with only a bonding agent as the base 240. In such embodiments, adjustments or forces exerted on the head 220 can be transferred to the tooth 212 to facilitate orthodontic treatments thereof through the smaller neck/base. In some embodiments, one or both of the head 220 or the bonding agent as the base 240 may be made from a flexible material.

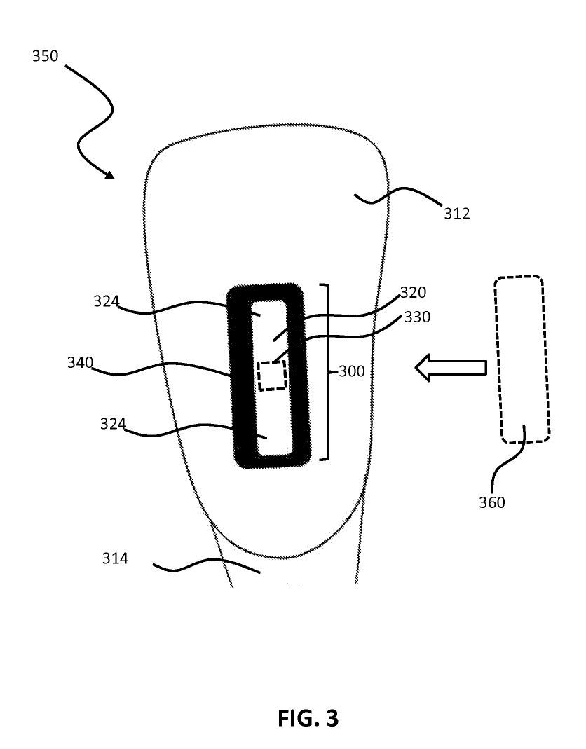

In some embodiments, an orthodontic system configured to transfer a force to a tooth is provided, the system comprising an orthodontic device such as an FOD configured to be attached to the tooth and an agent/member operable to engage the head such that actuation of the head facilitates physical adjustment of the tooth. FIG. 3 shows a top view of an example embodiment of a FOD 300 consistent with the description herein further including an agent/member 360 to define an orthodontic treatment system 350. This figure shows the system 350 having a tooth 312 such as crown or enamel on top of a root 314, the tooth 312 having an exterior surface. A FOD 300 can be configured to be attached to the exterior surface of the tooth 312 via a base 340. The agent/member may provide an actuation force to the FOD 300 and that actuation force deforms the FOD 300 so that the FOD 300 can elastically release this force and energy as a displacement force to the tooth 312. For illustration purposes, shown is an outline of an aligner well 360 of a larger agent/member. The agent/member may be operable to engage the head 320 such that actuation of the head 320 facilitates physical adjustment of the tooth 312. Actuation of the head 320 by the agent/member and forces exerted on the head 320 can be transferred to the neck (not shown) and onto the tooth 312, with or without the use of the base 340. The agent/member may also include any type of orthodontic device capable of transferring an actuation force to the FOD 300. In some embodiments, the agent/member is a rigid agent/member comprising for example only at least one of or any combination of a rigid metal, a plastic, an orthodontic aligner and a metal spring, among others. In some embodiments, the agent/member is a flexible agent/member comprising for example only at least one of or any combination of a flexible metal, an arch wire, a flexible plastic, an orthodontic aligner, a polymeric shell aligner and a metal spring, among others. In some embodiments, the agent/member includes any suitable orthodontic apparatus as can be appreciated by one skilled in the art. In some instances, adjustments to the tooth 312 can be made by physically actuating the head 320 by hand or by actuating the head 320 with another tooth.

Referring to FIG. 3, a profile of an aligner well 360 of an agent/member, such as a polymeric shell aligner, is shown that is configured to fit over the head 320 of the FOD 300 and provides the actuation force to the head 320. The aligner well 360 is a shaped recess in a larger aligner that is shaped to receive the head 320 and the alignment of the aligner well 360 is such that it can deform the FOD 300 with the actuation force and this deformation allows the FOD 300 to elastically release this energy as a displacement force to the tooth 312.

In some embodiments, as shown in FIG. 3, the geometric configuration of the head may further comprise flexible wings 324 configured to facilitate movement of the tooth 312 by allowing forces on the FOD as well as compression, flexion or tensile forces stored in the FOD to act as actuations to the head 320 via a rigid external agent/member such as a rigid metal or plastic material, or via a flexible external agent/member such as an orthodontic aligner, a polymeric shell aligner or metal spring. The head 320 may further have a substantially truncated pyramidal configuration (similar to FIG. 2A) having tapering wings 324.

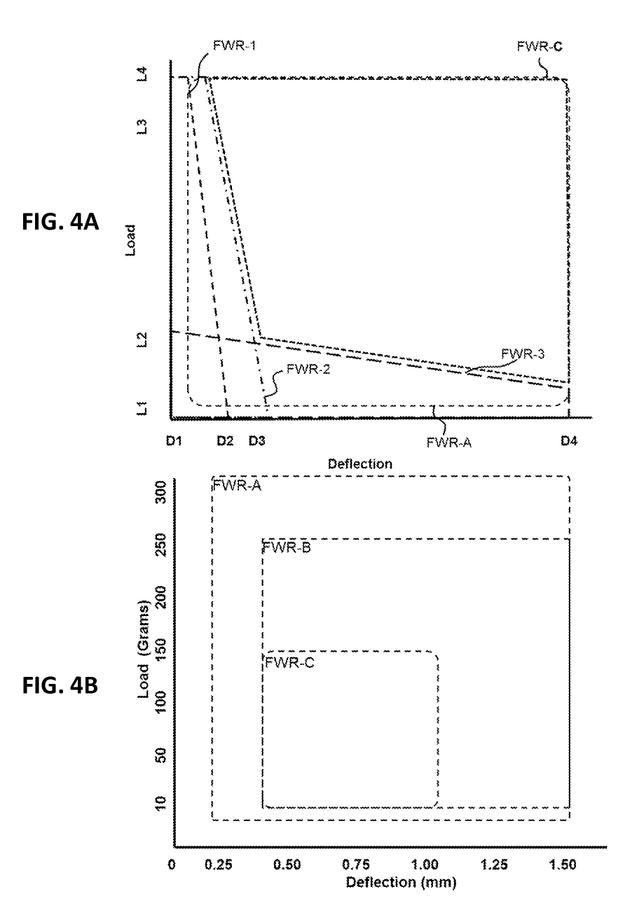

In some embodiments, the geometric configuration of the head 320 and the neck 330 include any geometric configuration capable of generating the forces desired onto the tooth. In some embodiments, those forces include those that satisfy the functional working ranges shown in FIG. 4A for the FOD 300. For example only and not for limitation, in some embodiments the neck 330 below (shown as seen through the head) can have a dimension of about 0.5 mm×0.5 mm while the wings 324 can have a length of about 1.25 mm extending outwardly from the sides of the neck 330. The length of the head 320 can be about 3 mm while the width of the head 320 can be about 1 mm. The depth of the flexible device 300, inclusive of the head 320 and the neck 330, can be about 1.5 mm. The FOD may be made from an elastic material such as Teflon.

In some embodiments, the neck 320 may have dimensions similar to those of a typical retainer or arch wire. In some embodiments, the neck 320 may have dimensions (e.g., thickness) larger than those of an arch wire. For example and not for limitation, some embodiments of the neck may have cross-sectional dimensions parallel to the attachment surface to the tooth having a thickness across its smallest dimension of at least about 0.3 mm, or at least about 0.5 mm, or at least about 1 mm, or at least about 2 mm or at least about 3 mm. In some embodiments, the cross-sectional area of the neck may be greater than about 0.09 mm², or greater than about 0.25 mm², or greater than about 1 mm², or greater than about 2 mm², or greater than about 4 mm², or greater than about 9 mm². In some embodiments, the cross-sectional area of the neck is a single solid cross-sectional area.

In some embodiments, the head 320 is rigid and the neck 330 is flexible with a geometric configuration capable of generating forces that satisfy the functional working range shown in FIG. 4A for the FOD 300.

Because of the intrinsic, flexible nature of the FOD 300, forces generated, via the wings 324 or the upper surface of the head 320, propagate to the tooth 312 in order to accomplish the desired tooth deflection. The force may be the result of a non-elastic or elastic force transferred from an external agent through the FOD to the tooth. The force may be in reaction to a tensile, compressive, flexural, or any combination of such forces, from the external agent or member. Specific forces and moments to accomplish various tooth movements can be varied to reflect the shape, size and nature of the physical properties of the flexible device 300 and the material it is made out.

FIG. 4A illustrates the relative working ranges of some embodiments of the FOD and the orthodontic system disclosed as compared to other solutions for moving teeth. In FIG. 4A the horizontal axis represents a deflection that can be provided by the FOD when coupled to a tooth, for example a deflection in millimeters from 0.00 mm to 1.50 mm. The vertical axis represents the load that can be applied to the tooth/FOD by external agent or member, for example a force in grams from 0 to 300 grams. When the FOD is used in a system with an agent/member, the external agent/member may be any orthodontic tool such as a wire, an elastic band, a retainer or an aligner such as a polymeric shell aligner. The functional working range illustrated is generally the area within the functional working range shapes shown. FWR-A represents the functional working range of some example embodiments of the FOD (without an agent/member) where the FOD is able to provide a load of L1 through L4 and provide this load over a range of deflection of D1 through D4. FWR-1 represents the functional working range of embodiments of another type of orthodontic device (without an agent/member), for example a common stainless steel bracket, that is able of providing a load of L1 through L4 over a range of D1 through D2. The deflection of this embodiment is limited because of the high Elastic Modulus and lack of flexibility in the device. If there is any flexibility in the device to allow the device to store energy, once this deflection is made, the load (stored as potential energy) on the device drops significantly. FWR-2 represents the functional working range of an inflexible device like that in FWR-1 but now working with a polymeric shell aligner as the agent/member. FWR-2 shows a functional working range of providing a load of L1 through L4 over a range of D1 through D3. The additional deflection may be provided by flexibility of the aligner. However, the deflection of this system embodiment has a significant limitation due to the Elastic Modulus and thickness of the aligner. Once the load (stored as potential energy) is expended over the deflection, the load on the device drops significantly. FWR-3 represent the functional working range of embodiments of a relatively inflexible device as used in another type of orthodontic system, for example a rubber band on a stainless steel bracket, that is able of providing a load of L1 through L2 over a range of D1 through D4. Although this embodiment is able to release a load (stored as potential energy) over a larger displacement, the load that can be applied is limited due to the low Elastic Modulus and limited practical dimensions of the device (e.g., rubber band).

Although the load and deflection values are not specified, differences between embodiments of the FOD can be seen by the comparison in FIG. 4A. As can be seen, FWR-A has a much larger working range than FWR-1 and is even greater than the function working ranges when the traditional stainless steel bracket is used with the polymeric shell aligner FWR-2 or with an elastic band FWR-3. This is due to the wider range of elastic properties that can be provided by the FODs disclosed. Because of the high Elastic Modulus of materials such as stainless steel and the plastics of aligners, and the thickness required to make the devices functional, the load vs deflection properties are limited (see FWR-1 and FWR-2). Although some orthodontic elements such as typical orthodontic bands may have a low Elastic Modulus, the space limitations in the mouth and their need to be coupled with other devices in the mouth, such as with a stainless steel bracket, limit the thickness of the band and therefore the load vs. deflection properties are limited by load (see FWR-3). In addition to accommodating loads from 0 to L4 and deflections from 0 to D4, FWR-C shows the functional working range “extension” possible by using the FOD as described herein with some of the systems being compared. The flexibility of the FOD is capable of adding additional deflection ranges as compared to aligner embodiments as shown at FRW-2 by supplementing the flexibility of the aligner with the flexibility of the FOD. The properties of the FOD may also provide additional load ranges over a deflection range as compared to FWR-3. This is because the FOD may be made from a material with a higher Elastic Modulus (e.g., higher than a rubber band) which may allow for more load to be stored by the FOD as potential energy. The FOD is able to deform (e.g., in compression, flexion or tension) and this energy will be released over the FOD's return to its original shape which is done by the tooth deflection. For embodiments of the FOD used with aligners, this additional deflection eliminates the need for as many aligners to provide the deflection required to move the tooth to the desired position.

It is understood that the elastic properties of the device is influenced both by the Elastic Modulus of the material and the shape of the material. As disclosed, the elastic properties of the FOD may have an Elastic Modulus in one of compression or tension ranging about 0.01×10⁷ to 180×10⁷ gf/cm² (0.01 to 180 GPa). For materials with Elastic Modulus ranges less than traditional devices, when the FOD is shaped similar to that traditional device and subjected to the same load as that traditional device, the FOD can provide a load over a greater deflection because the FOD deflects more initially to store the load as potential energy. For materials with Elastic Modulus measures much lower than traditional devices, the FOD can be shaped to take the same load as that traditional device and still provide a load over a greater deflection. For example, if the Elastic Modulus of the device material is one half of a traditional device, the cross-sectional profile of the FOD can be increase two times so that the FOD provides the same force transfer properties.

Since the deformation of the flexible portion of the FOD is also dependent upon the area the force is being applied to, suitable configurations of the flexible portion of the FOD may provide for specific properties for the device. FIG. 4B shows an example working range of a load to be applied to the tooth from some embodiments of the FOD over a range of deflections. This graph defines example ranges of forces by displacement of the FOD and not the combination of the force applied by the external agent/member (e.g., aligner) to the FOD. The graph in FIG. 4B shows the load onto the tooth which may range from 0 to 300 grams or more. FWR-A represents a functional working range similar to FWR-A of FIG. 4A. FWR-A may comprise a load range of about 0-300 grams over a range of deflections of about 0.25-1.50 mm. FWR-B may comprise a load range of about 10-350 grams over a range of deflections of about 0.50-1.50 mm. FWR-C may comprise a load range of about 10-150 grams over a range of deflections of about 0.50-1.00 mm. Other forces and deflections may be obtained with the FOD, however, forces and deflections shown in FIG. 4B are intended to reflect those typically applied in normal orthodontic situations. The deflection may be a movement of the tooth from one point in a direction from an original position of the tooth or the deflection may be a rotational movement of the tooth from the original position. Since the FOD is attached to the tooth, the deflection of the tooth is similar to the deflection of the FOD from an original position.

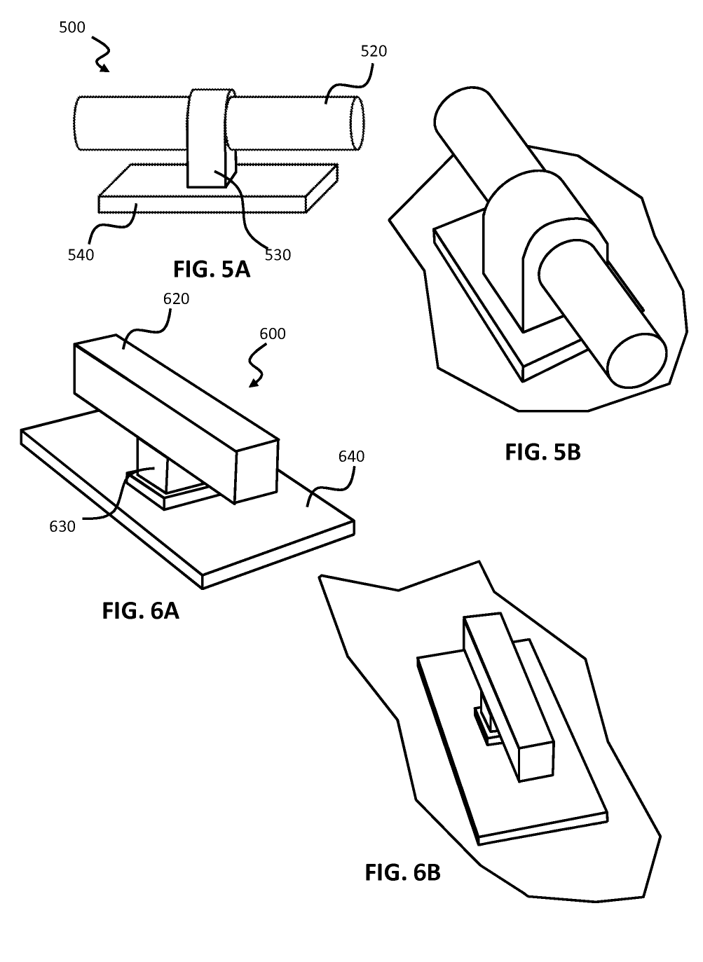

FIG. 5A illustrates one example embodiment of a FOD having a cylindrical head 520, a neck 530 and a base 540. FIG. 5B is a top perspective view of the embodiment of 5A as if was attached to the surface of a tooth.

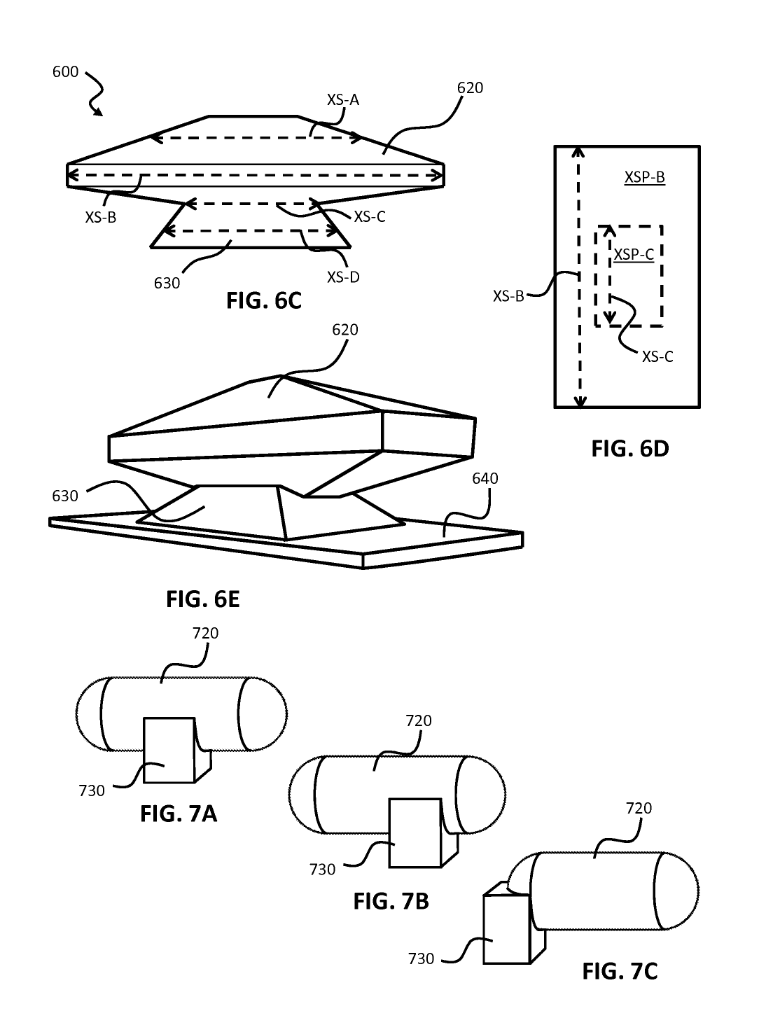

FIG. 6A illustrates one example embodiment of a FOD having a rectangular head 620 along with a neck 630 and a base 640. FIG. 6B is a top perspective view of the embodiment of 6A as if was attached to the surface of a tooth.

FIGS. 6C-6E illustrate one example embodiment of the FOD having a multi-sided head 620, a multi-sided neck 630 and a base 640. FIG. 6C also illustrates some of the geometric properties of some embodiments of the FOD. XS-A, XS-B, XS-C and XS-D represent cross-sectional planes and a dimension of a cross-sectional profile of the FOD in planes parallel to the plane of attachment of the device to an attachment surface of the tooth. Each of these cross-sections define a cross-sectional profile and cross-sectional area of the device and device elements of which XS-A, XS-B, XS-C and XS-D represent one dimension of each of the profiles at that cross-section. As can be seen, the neck 630 has a plurality of cross-sectional profiles and cross-sectional areas, two of which are defined in the plane of XS-C and XS-D. Also, the head 620 has a plurality of cross-sectional profiles and cross-sectional areas, two of which are defined in the plane of XS-B and XS-A. XS-B illustrates a cross-sectional profile with a perimeter that is larger than the perimeter of XS-A. In this example, XS-B illustrates the cross-sectional profile of the head 620 with the largest perimeter and XS-C illustrates the cross-sectional profile of the neck 630 with the smallest perimeter. FIG. 6D illustrates cross-sectional profile XSP-B (within solid lines) of the head at cross-sectional plane XS-B with XS-B illustrating the length of that profile and area and cross-sectional profile XSP-C (within dotted lines) of the neck at cross-sectional plane XS-C with XS-C illustrating the length of that profile and area. As illustrated in FIGS. 6C-6E, the head 620 may be sized with its largest cross-sectional area and perimeter being any size larger than the smallest cross-sectional area and perimeter of the neck 630. In some embodiments, the relationship of the largest perimeter of the head 620 to the smallest perimeter of the neck 630 is at least 1.5 time larger, in some embodiments at least 2 times larger, in some embodiments at least 2.5 larger, in some embodiments at least 3 times larger, in some embodiments at least 4 time larger and in other embodiments it is at least 5 times larger.

Also shown in the examples of FIGS. 6C-6E, embodiments of each of the head 620 and the neck 630 may have a geometric configuration defining each of the head and the neck as a single solid element with a single solid shape with one or more single solid cross-sectional profiles and single solid cross-sectional areas. In some embodiments, the first geometric configuration defines a single first solid shape and the second geometric configuration defines a single second solid shape. In other words, the head and the neck may be configured as solid elements not configured as multiple elements such as multiple prongs to define the head or neck.

FIGS. 7A-7C illustrate example embodiments of how the head 720 may be positioned in relation to the neck 730 of the FOD.

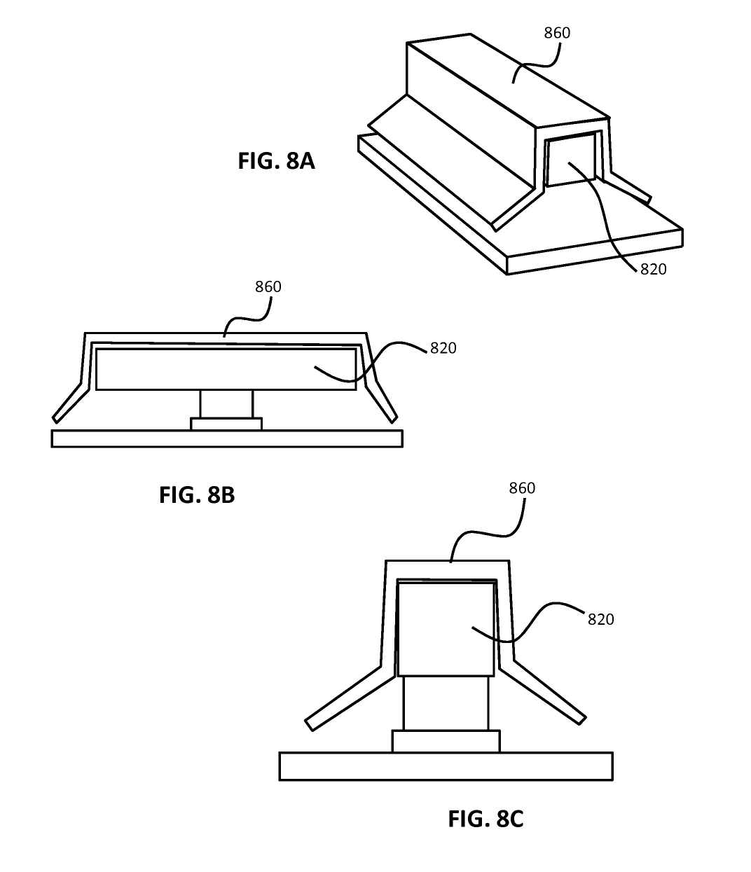

FIGS. 8A-8C illustrate different views of an example embodiment of a FOD and an aligner well of an aligner as an agent/member 860 fitting over the FOD head 820.

As discussed herein, embodiments of the head may have any geometric configuration such that actuation of the head facilitates adjustment of the tooth as desired for the orthodontic application. In some embodiments, the geometric configuration includes any shape suitable to receive and transfer forces to the tooth given the materials used to make the head. For example, and not for limitation, geometric configurations for the head may include a two-dimensional cross-sectional profile of a circle, an ellipse, a triangle, a square, a rectangle, a parallelogram, a diamond, a pentagon, a hexagon, an octagon, a polygon and a trapezoid. The cross-sectional profile may be defined as the shape of the FOD element in a two-dimensional plane either generally parallel or generally perpendicular to the surface of the FOD that will be attached to the attachment surface of the tooth. For example, and not for limitation, the geometric configuration may also include a three-dimensional shape including one of a polyhedron, a cube, a sphere, a cone, a cylinder, a ball, a prism and a pyramid.

The neck may also have geometric configuration that facilitates a transfer of the actuation force to a displacement force and displacement or adjustment of the tooth as desired for the orthodontic application. The geometric configuration may be any shape suitable to receive and transfer forces to the tooth given the materials used to make the head and neck. For example, and not for limitation, geometric configurations for the neck may include any of the two-dimensional cross-sectional profiles or three-dimensional shapes of the head. In some embodiments, the geometric configuration of the neck may include the shape of a coil or a spring. In some embodiments, the head and the neck may be integrated as a single unit. In other words, the head and the neck can be fabricated using the same material. In some embodiments, the head and neck can be manufactured using different materials and subsequently attached, bonded or otherwise coupled. For example only and not for limitation, the head may be made of a Teflon material and the neck may be made of a nitinol coil spring. The shape and size of the head as well as that of the neck can be customized. In some embodiments, the neck functions like a pedestal to provide the necessary spacing between the head and the tooth. In other words, the neck allows the head to flex in response to an actuation force while still not being in direct physical contact with the tooth. In some embodiments, the neck may be a measurable, visual extension from the head, or it may exist minimally as a flush surface area of the head which is attached to the tooth or base.

In some embodiments the geometric configuration of the head and/or the neck may be a solid three-dimensional shape.

In some embodiments, the geometric configuration of the neck and the head allow different relative properties between the neck and the head. For example, if the head and neck are made of similar materials and the neck has a geometric configuration smaller than that of the head, the strength and resistance to deformation properties of the neck in flexure, compression and tension may be less than similar properties of the head. Additionally, if the head and neck are made of different properties with similar geometric configurations and the neck material has a lower Elastic Modulus than the Elastic Modulus of head, the strength and resistance to deformation properties of the neck in flexure, compression and tension may be less than similar properties of the head. For example, referring to FIGS. 8A-8C, if the neck and the head are made of the same material, the strength of the neck in flexure would be less than the strength of the head in flexure. This is primarily due to the smaller dimensions, those influencing flexural strength, of the neck compared to the head. Similarly, if the neck in FIGS. 8A-8C were made of a material that had a lower Elastic Modulus than the head, the strength of the neck in flexure would again be less than the strength of the head in flexure. Similar differences in strength in compression and tension may also be created by different geometric configurations.

In some embodiments, the head and the neck together can be coupled to the tooth via the base, which, too, can be customized. The base may be integrated with the head and the neck and be fabricated using the same material. In other embodiments, the base, head and neck can be manufactured using different materials and subsequently attached, bonded or otherwise coupled.

In some embodiments, elements or portions of elements of the FOD may be made from a flexible material including an elastic material. Any one or more in any combination of the head, the neck, the base or the adhesive may be made from a flexible material. Any material with a suitable elasticity modulus to receive an actuation force and transfer or store that force may be used. In other words, suitable materials include those that when used with the geometric configuration of the device elements are able to take the actuation force and store or transfer some or all of that actuation force through compression, tension, torsion, flexion or other elastic force. For example only, and not for limitation, examples of suitable flexible materials including at least one of natural rubbers, rubbers, colloids, hydrocolloids, gels, silicones, polymers, elastomers, super-elastic metal alloys, and crystals, among others, alone or in combination. For illustration only and not for limitation, example embodiments of a suitable flexible material may include those disclosed in U.S. Pat. No. 4,717,341 issued Jan 5, 1988 to A. Jon Goldberg et al. the contact of which is incorporated herein by reference in its entirety.

In some embodiments, the geometric configuration of the FOD, including the head and/or the neck and/or the base include those geometric configurations capable of generating forces as required by the orthodontic application. In some embodiments, the geometric configurations include those capable of satisfying the functional working ranges shown in FIG. 4B of the FOD.

In some embodiments, the head can be made of a rigid material while the neck can be made of the flexible material. In other embodiments, the neck can be made of a rigid material while the head can be made of a flexible material. In yet other embodiments, each of the head and the neck can be made of a rigid material.

In some embodiments, the neck and/or the head can be made of a rigid material and the base is made of a flexible material. In some embodiments, the base has one of the base pad or the bonding agent made from a flexible material.

In some embodiments, the flexible material is one that has an Elastic Modulus that allows forces to be transferred and/or stored elastically so that they can be release over a period of time and/or over a range of deflection. In some embodiments, the Elastic Modulus of the flexible material is a modulus less than a rigid steel. In some embodiments, the Elastic Modulus of the flexible material may be higher than a soft rubber used in soft rubber bands. In some embodiments, the flexible material has an elastic material having an Elastic Modulus (in compression or tension) less than that of Stainless Steel or less than about 194×10⁷ gf/cm² (190 GPa, 27.6×10⁶ psi). In some embodiments, the Elastic Modulus is less than that of Titanium (including Nickel-Titanium or Beta-Titanium) or less than about 102×10⁷ gf/cm² (100 GPa, 14.5×10⁶ psi). In some embodiments, the Elastic Modulus is less than that of a reinforced plastic or less than about 30.6×10⁷ gf/cm² (30.0 GPa, 4.4×10⁶ psi), in some embodiments it is less than that of nylon or less than about 10.5×10⁷ gf/cm² (10.3 GPa, 1.5×10⁶ psi), in some embodiments it is less than that of polyvinylchloride or less than about 4.1×10⁷ gf/cm² (4.1 GPa, 0.6×10⁶ psi), in some embodiments it is less than that of PTFE/Teflon or less than about 0.3×10⁷ gf/cm² (0.3 GPa, 0.04×10⁶ psi) and in some embodiments it is consistent with that of rubber and less than about 0.10×10⁷ gf/cm² (0.1 GPa, 0.01×10⁶ psi). In some embodiments, the geometric configuration of the FOD (made with the flexible material) and the Elastic Modulus of the flexible material are configured to transfer an actuation force in a range of about 0-300 grams-force to the tooth. In some embodiments, the geometric configuration of the FOD and the Elastic Modulus of the flexible material are configured to transfer an actuation force in a range of about 10-250 grams and in some embodiments a range of about 10-150 grams. In some embodiments, the geometric configuration of the flexible portion is configured to transfer the actuation force over a displacement of the device of at least about 0.10 mm. In some embodiments, the flexible portion is configured to transfer the actuation force over a displacement of the device of at least about 1.00 mm. In some embodiments, the flexible portion is configured to transfer the actuation force over a displacement of the device of at least about 1.50 mm. In some embodiments, the flexible portion is configured to transfer the actuation force over a displacement of the device in a range of about 0.25 mm-1.50 mm, or 0.50-1.50 mm or 0.50 mm-1.00 mm.

Since some embodiments of the flexible material may have an Elastic Modulus lower than traditional attachments for traditional flexible aligners, similarly dimensioned embodiments of the FOD are expected to be able to provide a greater displacement than the traditional solution when used with flexible aligners. For example, a FOD made from a material with a lower Elastic Modulus than another device of a similar design, will be able to deform more given the same actuation force allowing the more flexible FOD to return that force over a greater displacement. This may allow for fewer flexible aligners to be provided to obtain the same displacement results on the tooth.

Some embodiments of the FOD are able to provide actuation forces onto a tooth that are not primarily provided by the flexing of the device. Some embodiments of the disclosed FOD are also able to provide forces onto the tooth by absorbing forces in compression or tension of the FOD and transferring these forces as actuation forces onto the tooth. As described above, the geometric configuration and the material the FOD is made from can allow significant forces can be absorbed and released through the compression or tension of the FOD. Embodiments of the FOD that provide significant actuation forces through one of compression or tension are different than the embodiments disclosed in U.S. Pat. No. 8,562,337 issued on Oct. 22, 2013 which primarily provide actuation forces through the flexure of the device. Embodiment of the disclosed FOD can provide actuation forces through flexure, being able to provide forces only through compression or tension, or being able to provide additional forces through compression or tension allows for a broad range of forces onto and displacements of the tooth.

Although the current description has been described in detail with reference to several embodiments, additional variations and modifications exist within the scope and spirit of the disclosure.

### One Example Embodiment of Methods to Use the Orthodontic Device:

In operation, a method of using a flexible orthodontic device for orthodontic treatment generally includes providing a FOD as described herein, coupling the FOD to the tooth and providing an actuation force onto the FOD whereby the force is transferred to the tooth and repositions the tooth.

In some embodiments, the coupling step comprises coupling the FOD to an exterior surface of a tooth using a bonding agent as described herein. In one embodiment, the FOD includes a neck and a head connected to the neck, the head and the neck each having a geometric configuration. The method may also include actuating the head such that the actuating step facilitates physical adjustment of the tooth.

In some embodiments, providing the actuation force comprises exerting lateral forces, longitudinal forces, push forces, pull forces, flex forces and twisting forces, among other types of forces on the head. In some embodiments, the actuating step includes exerting elastic forces, inelastic forces or mechanical forces on the head, optionally with the use of the external member/agent or by hand. The actuating forces applied to the head may be transferred to the tooth through the neck. In one embodiment, the actuating step can be carried out with an external agent or member including for example at least one of rigid metal, plastic, orthodontic aligner, polymeric shell aligner and metal spring, among others. In another embodiment, the actuating step can be made by physically actuating the head by hand. In operation, the agent/member is operable to engage the head such that actuation of the head facilitates physical adjustment of the tooth. Actuation of the head by the external agent/member and forces exerted on the head can be transferred to the neck and onto the tooth, with or without the use of the base. In some embodiments, the external agent/member includes at least one of rigid metal, plastic, orthodontic aligner, polymeric shell aligner and metal spring, among others. In other embodiments, the external agent member includes any suitable orthodontic apparatus as can be appreciated by one skilled in the art.

In operation, the FOD is able to flex, compress, bend, stretch or otherwise deform when appropriately engaged by the external agent/member. This flexing, compressing, bending, stretching or otherwise deforming allows the FOD to absorb and store potential energy as elastic potential energy. This potential energy is able to be released as work and when applied to a tooth, this work is released as a force over a distance/displacement. For example, the flexible material may be configured to absorb a portion of the force applied as a potential energy and transfer the force in grams-force to the tooth over a displacement of the device.

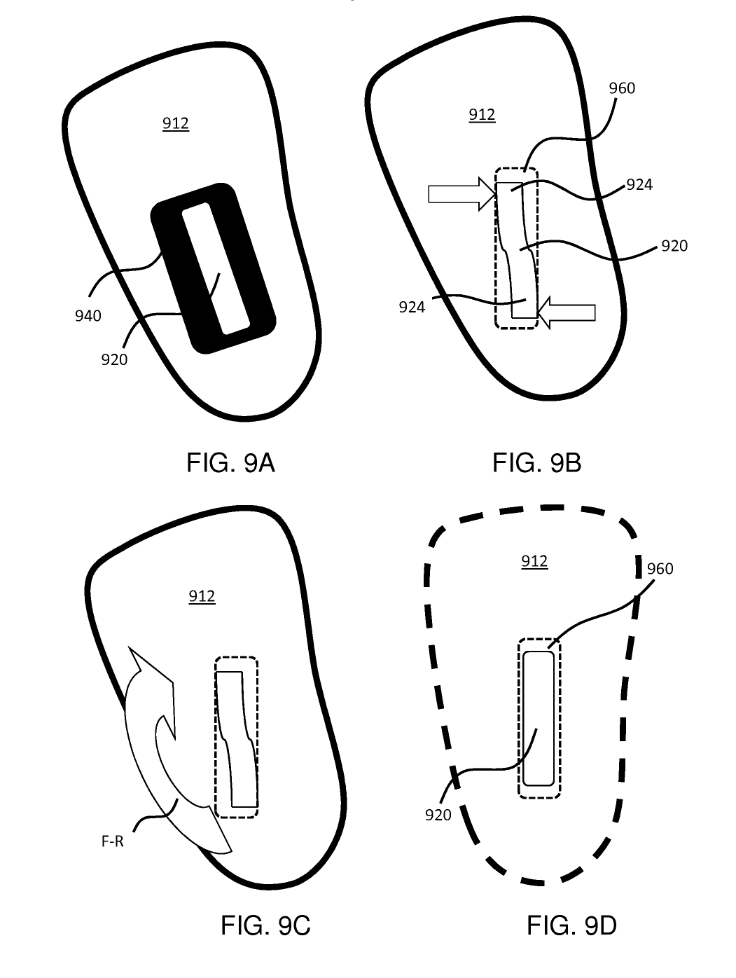

FIGS. 9A-9D illustrate the operation of one example embodiment of an FOD as described herein. At FIG. 9A is shown a tooth 912 with a FOD attached to its surface. In this example, the base 940 and the head 920 of the FOD are shown. It is desired to rotate this tooth in a clockwise direction consistent with the orientation shown in FIG. 9D. To rotate the tooth, an aligner well 960 is positioned such that it will put an actuation force from the well contact surface onto the contact surface of the head 920 as shown in FIG. 9B. The well contact surface and the contract surface of the head being the points of contact between the well and the head. This actuation force deforms the flexible head 920 and this is translated through the head and a central neck (not shown) to the base and the tooth 912 resulting in the displacement force F-R (rotation) onto the tooth as shown in FIG. 9C. As the FOD releases the elastic energy stored from the original deformation of the head and/or the neck through the displacement force onto the tooth, the tooth rotates to a position where there is no more actuation force applied as shown in FIG. 9D.

As shown in FIGS. 9A-9D, configurations of the FOD may allow a longer moment arm and more specific placement of the force onto the tooth. For example, as shown in FIGS. 9A-9D, when the FOD has a single, central neck, the length of the wings 924 allow for a longer moment arm from this central neck and therefore allows for more of a torque force to be applied to the tooth. This may particularly be helpful when the element or agent/member applying the force onto the FOD may be limited. For example, if the element or agent/member applying the actuation force is a polymeric shell, the force it applies may be limited by its dimensions and/or its Elastic Modulus. By increasing the moment arm that applies this force to the tooth, a smaller force is needed from the polymeric shell onto the FOD to apply the same torque to the tooth.

It is understood that the same operation may result from a FOD having a rigid head and another element of the FOD being made from a flexible material. For example, and not for limitation, in embodiments that have a neck made from flexible material, the deformation and the elastic potential energy could come from the neck.

It is also anticipated that the whole elements, such as a head, a neck or a base, need not be made totally of the flexible material. For example, only a portion of the head, neck or base may be made of the flexible material.

It is also understood that the FOD may operate based on the compression or tension of the flexible material and the displacement may be in a linear direction, in addition to or in lieu of a rotation.

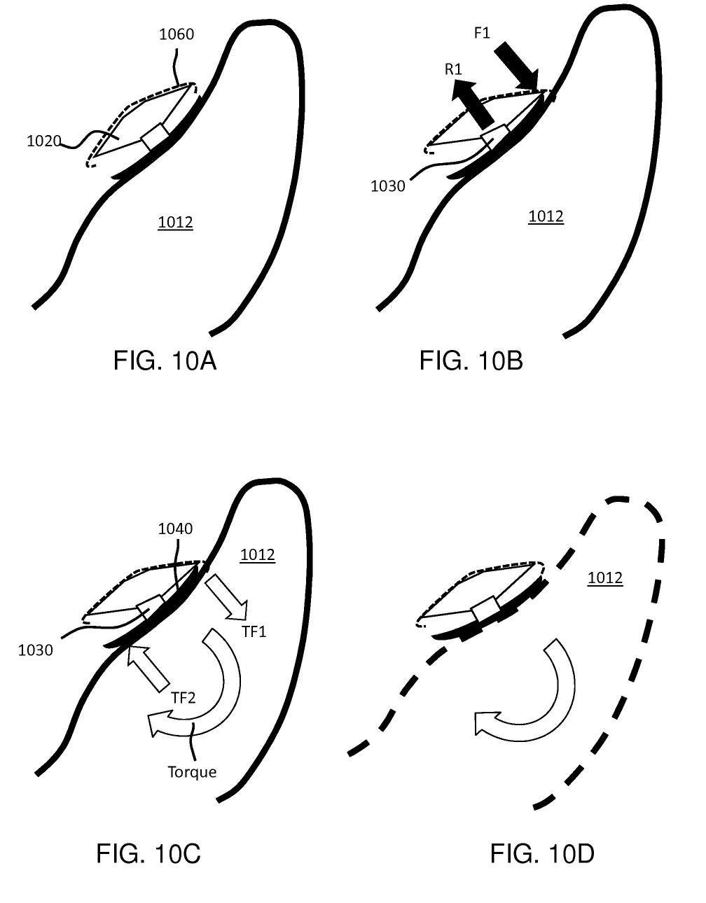

FIGS. 9A-9D and 10A-10D illustrate the ability of the orthodontic device to be able to receive an actuation force that creates a torque on the tooth and the geometric configuration of the flexible portion is configured to transfer the actuation force over a rotational displacement of the device.

FIGS. 10A-10D illustrate the operation of one example embodiment of an FOD as described herein. This embodiment illustrates the moving of a tooth from the state shown in FIG. 10A to the state of FIG. 10D. FIG. 10A shows the tooth, an outside agent 1060 (e.g., an aligner well) and FOD (head 1020) in a passive initial state. FIG. 10B shows the application of the outside agent force F1, as an actuation force, onto the FOD with the reactionary force R1 from the FOD also being shown. FIG. 10C shows the force transmitted through the neck 1030 into displacement forces TF1 and TF2 onto the tooth 1012 which, in this embodiment, results in the torque shown. FIG. 10C also shows the distortion/conformity of the FOD to the aligner well and the transmission of the actuation force onto the FOD and onto the tooth 1012 via the neck 1030 and base 1040. FIG. 10D shows the resulting tooth movement into a passive well/FOD state.

As shown in FIGS. 10A-10D, configurations of the FOD are able to uniquely translate a force applied generally perpendicular to the surface of the tooth as a torque to the tooth. As described above with respect to FIGS. 9A-9D, configurations are also able to provide torque from the force being applied generally perpendicular to the surface onto the tooth. In embodiments that apply a torque, less force may be needed to come from the element applying the force because the geometric configuration of the FOD elements may allow a longer moment arm than other devices.

As has been shown and described, some embodiments of the FOD are capable of providing efficient forces and moments in three dimensions to accomplish various tooth movements. The forces and moments onto the tooth can be varied by the method of applying the force as well as varying the shape, size and material properties of the flexible device.

Although this invention has been described in the above forms with a certain degree of particularity, it is understood that the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention which is defined in the claims and their equivalents.

We claim:

1. An orthodontic system for repositioning a tooth, the orthodontic system comprising:
an orthodontic device comprising a head and a neck configured to be coupled to a tooth;
the head having a first geometric configuration such that actuation of the head facilitates repositioning the tooth;
the neck adjacent the head to facilitate coupling of the head to the tooth;
the neck having a second geometric configuration;
the neck operable to transfer a force exerted to the head to the tooth;
at least one of the neck and the head comprising a flexible material;
a polymeric shell aligner having a well and a well contact surface;
the head configured to be removably received in the well; and
the head having a head contact surface configured to engage the well contact surface whereby the well contact surface is capable of transferring the force to the head contact surface and actuating the head.

2. The orthodontic system of claim 1 wherein:
the first geometric configuration defining a single first solid shape; and
the second geometric configuration defining a single second solid shape.

3. The device of claim 2 wherein:
each of the first and second solid shapes defining a plurality of cross-sectional profiles in a plane generally parallel to an attachment surface of the tooth;
each of the plurality of cross-sectional profiles defining a cross-sectional area; and
a largest cross-sectional area of the first solid shape being at least about 2 times greater than a smallest cross-sectional area of the second solid shape.

4. The orthodontic system of claim 1 wherein the flexible material is an elastic material having an Elastic Modulus in one of compression or tension less than about 30.6×10⁷ gf/cm².

5. The orthodontic system of claim 1 wherein the flexible material is an elastic material having an Elastic Modulus in one of compression or tension less than about 0.1×10⁷ gf/cm².

6. The orthodontic system of claim 1 wherein:
the head comprises a first material with a first Elastic Modulus in one of compression or tension; and
the neck comprises a second material with a second Elastic Modulus in one of compression or tension different than the first Elastic Modulus.

7. The orthodontic system of claim 6 wherein the head comprises a Teflon material and the neck comprises a nitinol coil spring.

8. The orthodontic system of claim 1 wherein:
the flexible material is configured to absorb a portion of the force as a potential energy and transfer the force in a range of about 10-300 grams-force to the tooth over a displacement of the device of at least about 1.0 mm.

9. The orthodontic system of claim 1 wherein:
the flexible material is configured to absorb a portion of the force as a potential energy and transfer the force in a range of about 25-150 grams-force to the tooth over a displacement of the device in a range of at least about 0.5-1.0 mm.

10. An orthodontic device comprising:
a head configured to be coupled to a tooth;
the head having a first geometric configuration such that actuation of the head facilitates an adjustment of the tooth;
a neck adjacent the head to facilitate attachment of the head to the tooth;
the neck having a second geometric configuration;
the neck operable to transfer a force exerted on the head to the tooth; and
at least one of the neck and the head comprising a flexible material.

11. The device of claim 10 wherein the flexible material is an elastic material having an Elastic Modulus in one of compression or tension less than about 0.3×10⁷ gf/cm².

12. The device of claim 10 wherein:
the flexible material is configured to absorb a portion of the force as a potential energy and transfer the force in a range of about 5-300 grams-force to the tooth over a displacement of the device of at least about 1.0 mm.

13. The device of claim 10 wherein the flexible material comprises at least one of a natural rubber, a rubber, a colloid, a hydrocolloid, a gel, a silicone, a polymer, an elastomer and a crystal.

14. The device of claim 10 wherein:
the flexible material is an elastic material;
the neck comprising the elastic material; and
the elastic material having an Elastic Modulus in one of compression or tension less than about 30.6×10⁷ gf/cm².

15. The device of claim 14 wherein the elastic material having an Elastic Modulus in one of compression or tension less than about 0.3×10⁷ gf/cm².

16. The device of claim 10 wherein the second geometric configuration defines a single solid cross-sectional area greater than about 2 mm²; and
a strength in flexure of the neck is less than a strength in flexure of the head.

17. The device of claim 10 wherein:
the first geometric configuration defining a single first solid shape;
the second geometric configuration defining a single second solid shape;
each of the first and second solid shapes defining a plurality of cross-sectional profiles in a plane parallel to an attachment surface of the tooth;
each of the plurality of cross-sectional profiles defining a cross-sectional area; and
a largest cross-sectional area of the first solid shape being at least about 2 times greater than a smallest cross-sectional area of the second solid shape.

18. The device of claim 10 wherein:
the first geometric configuration defining a first solid three-dimensional shape comprising one selected from the group comprising a polyhedron, a cube, a sphere, a cone, a cylinder, a ball, a prism and a pyramid; and
the second geometric configuration defining a second solid three-dimensional shape comprising one selected from the group comprising a polyhedron, a cube, a sphere, a cone, a cylinder, a ball, a prism and a pyramid.

19. The device of claim 10 further comprising:
a member operable to engage the head such that actuation of the head facilitates physical adjustment of the tooth; and
the member comprises a polymeric shell aligner and the polymeric shell aligner further comprises at least one well configured to engage the head.

20. The device of claim 10 further comprising:
a member operable to engage the head such that actuation of the head facilitates the adjustment of the tooth; and
the member comprises one of a wire, an aligner, a metal spring and an elastic band.
